(19) United States
(12) Patent Application Publication
(10) Pub. No.: US 2026/0359764 A1
(43) Pub. Date: Nov. 12, 2026

(54) System and Method for Generating and Maintaining a Career-Long Verifiable Service-Performance Credential

(71) Applicant: Ari ATTIAS, Olhao (PT)

(72) Inventor: Ari ATTIAS, Olhao (PT)

(21) Appl. No.: 19/361,184

(22) Filed: Oct. 17, 2025

Related U.S. Application Data
(63) Continuation-in-part of application No. 19/204,499, filed on May 10, 2025.

(51) Int. Cl. G06Q 10/0639; G06F 21/60

(52) U.S. Cl. CPC G06Q 10/06393; G06F 21/602

(57) ABSTRACT

The present invention relates to systems and methods for generating and maintaining a verifiable, career-long service-performance credential for individuals. The system establishes a user account associated with a persistent identifier that remains linked to the individual throughout their professional life. Verified ratings, attestations, and interaction data are aggregated and processed by a scoring engine that applies recency weighting, normalization, and statistical confidence analysis to compute at least one performance score. A credential generator produces a cryptographically signed credential incorporating the score and verification metadata, which can be securely shared and validated without exposing underlying data. Privacy controls allow users to determine which categories of information are visible to verifiers, while fraud detection mechanisms monitor for anomalous rating activity. The resulting credential provides a portable, tamper-evident, and continuously verifiable record of professional performance across multiple employment contexts, enhancing trust and transparency in digital workforce ecosystems.

### BACKGROUND OF THE INVENTION

### Field of Invention

The present invention relates generally to digital credentialing and workforce reputation management systems. More specifically, it pertains to a system and method for generating, maintaining, and verifying an individual's service-performance record throughout the course of their career using cryptographically verifiable credentials accessible through scannable or digital identifiers.

### Brief Summary of the Invention

The present invention provides a system and method for generating and maintaining a persistent, career-long verifiable service-performance credential for individuals engaged in service-related professions. The system establishes a user account linked to a unique, persistent identifier that remains associated with the individual throughout their professional life. This identifier, accessible through a scannable or digital medium, enables seamless tracking and verification of performance data across multiple employment contexts.

The system aggregates service interaction data, including verified customer ratings, employer attestations, and performance feedback, to produce one or more performance scores representing the individual's professional reputation. These scores are calculated using weighted algorithms that incorporate recency bias and statistical confidence measures to ensure fair and dynamic representation of an individual's ongoing performance.

A verification module generates a digitally signed credential that encapsulates the individual's performance record and authenticates its integrity through cryptographic verification. This credential may be shared selectively through a digital interface, allowing users to present a verifiable record of their professional performance to prospective employers, clients, or digital platforms.

Privacy and disclosure controls are integrated into the system, enabling users to determine which aspects of their professional history are visible to others. The system enforces minimum thresholds for verified interactions prior to credential publication, and it supports revocation, reissuance, and privacy-based updates to credentials as needed. Through these mechanisms, the invention delivers a secure, portable, and tamper-resistant career credential that enhances professional transparency, reduces fraudulent claims, and promotes trust within employment and service ecosystems.

### BRIEF DESCRIPTION OF THE FIGURES

FIG. 1 illustrates a system architecture in which client applications communicate through an API gateway with backend services responsible for identity management, interaction logging, credential generation, and verification.

FIG. 2 depicts the core data model linking an employee entity with multiple interactions, score windows, credentials, attestations, and privacy profiles that control data visibility.

FIG. 3 shows the operational flow for rating ingestion and score computation, including validation, storage, weighted scoring, percentile calculation, and score update events.

FIG. 4 presents a credential issuance and verification sequence that includes payload construction, digital signing, badge generation, and real-time verification of credential authenticity.

FIG. 5 illustrates the privacy control process through which users configure disclosure settings, apply visibility policies, and revoke credential access when desired.

FIG. 6 illustrates the badge and certificate generation process, including asset rendering, embedding of QR codes and cryptographic fingerprints, and controlled revocation display upon credential invalidation.

FIG. 7 presents the security and anti-fraud pipeline designed to ensure data authenticity through eligibility gating, anomaly detection, abuse prevention, key rotation, and immutable audit logging.

### DETAILED DESCRIPTION

The present invention provides a comprehensive digital framework for generating and maintaining a verifiable service-performance credential that persists across the duration of an individual's career. The system is architected as a distributed, computer-implemented environment that facilitates the secure recording, aggregation, verification, and controlled dissemination of performance-related data associated with service professionals. At its core, the system comprises interconnected modules responsible for identity management, rating collection, credential generation, privacy control, and verification, all operating within a secure and scalable computing environment.

The system architecture is designed to operate across a network of client devices and backend servers. Each client device, which may include smartphones, tablets, laptops, or desktop computers, runs an application or web-based interface through which users interact with the credentialing system. Employees use the application to manage their profiles, view ratings, request credential updates, and configure privacy preferences. Employers and customers may use companion interfaces to submit ratings, provide attestations, or verify existing credentials. Communication between client interfaces and backend services occurs via a secure application programming interface (API) gateway that enforces authentication, authorization, and encryption protocols to preserve the confidentiality and integrity of all data exchanges.

The system backend comprises multiple services that collectively support the lifecycle of the credential. An identity management service is responsible for establishing and maintaining a persistent identifier that uniquely corresponds to each user. This identifier, which remains constant throughout the user's professional life, is generated using cryptographically secure methods to prevent duplication or impersonation. The identifier functions as the root reference linking all data entities associated with the user, including ratings, attestations, and verification records. By decoupling the identifier from any specific employer or platform, the invention ensures that the credential remains portable and verifiable even as the user transitions between different employment environments.

A rating service captures and records service interactions between users and the entities providing feedback. These interactions may originate from direct customer transactions, employer evaluations, or peer assessments, depending on the deployment context. Each interaction record includes metadata such as time, date, interaction type, rating value, and contextual information that allows the system to apply weighting algorithms during score computation. To maintain data integrity, all interactions are validated upon ingestion to confirm authenticity, prevent duplication, and ensure that only verified raters contribute to the user's performance profile.

A credential generation service transforms aggregated rating data into a verifiable digital credential. This service interacts with a cryptographic module that produces a digitally signed credential payload. The payload contains the user's identifier, performance scores, attestation information, and a verification signature. The cryptographic signature is generated using a key management subsystem that supports periodic key rotation to ensure long-term security. This digital credential may be stored within the system or exported in various interoperable formats, such as digital badges or certificates, enabling users to share their verified credentials across different professional or social platforms.

The verification service acts as a gateway for external parties, such as employers or clients, to validate the authenticity of a credential. Upon receiving a verification request, the service retrieves the corresponding credential data, confirms the validity of the cryptographic signature, and returns a verification response that indicates whether the credential remains active, revoked, or expired. This verification process operates independently of the originating employer or rating source, ensuring that the credential is tamper-evident and objectively verifiable regardless of its age or origin.

The system further includes a privacy and policy management subsystem that governs how data are accessed and disclosed. Users are empowered to define visibility parameters for different categories of information, such as overall scores, rating details, or employer attestations. These preferences are stored as structured policies that determine how credential data are assembled during generation and how they are rendered to third parties during verification. The system enforces these privacy rules automatically, ensuring that no data outside the user's disclosure preferences are revealed during credential viewing or sharing.

Scalability and interoperability are central to the system's architecture. The modular design allows the invention to operate across cloud-based or hybrid infrastructures, enabling enterprise-level scalability and high availability. Each subsystem communicates via standardized data schemas and interfaces, ensuring compatibility with external applications such as résumé platforms, professional networking sites, and human resource management systems. This interoperability extends the utility of the credential beyond a closed ecosystem, promoting universal recognition of verified service performance across industries.

Security considerations are embedded throughout the architecture. All communication channels are protected using transport layer encryption, and sensitive data at rest are secured using symmetric or asymmetric cryptographic algorithms. The system maintains comprehensive audit logs for every credential-related event, including rating submissions, credential issuances, and verification attempts. These logs are immutable, providing traceability and transparency in the event of disputes or audits. Access to administrative functions is restricted through multi-factor authentication and role-based permissions, further safeguarding the system from unauthorized manipulation.

The overall design of the system enables continuous, trustworthy, and portable recognition of professional service performance. By combining decentralized verification with user-controlled privacy and cryptographic validation, the invention delivers a robust technological infrastructure that enhances credibility within professional ecosystems while mitigating the risk of falsified credentials or manipulated performance records. Through its modular and secure architecture, the system establishes a foundation for career-long reputation portability and verifiable trust in digital employment contexts.

The system underlying the invention is structured around a cohesive and extensible data model that ensures persistent association between an individual and their verifiable service-performance record over the duration of their career. This data framework defines how information related to service interactions, ratings, attestations, privacy preferences, and verification events are stored, organized, and updated. Each element of the data structure is designed to maintain referential integrity, scalability, and compliance with security and privacy standards. The architecture ensures that the credential remains continuously valid, tamper-evident, and portable, regardless of the number of employment changes or platforms through which the user engages.

At the center of the data model is the concept of a persistent identifier. This identifier functions as a cryptographically unique token permanently associated with a particular user. The persistent identifier is generated by the identity management subsystem at the time a new account is established. Unlike conventional account identifiers that are confined to specific employers or platforms, this identifier is globally unique and detached from any specific organizational ownership. The generation process involves applying a secure hashing or cryptographic key generation algorithm that produces an identifier resistant to collision, impersonation, or replication. Once assigned, this identifier serves as the primary key linking all subsequent data entities, including ratings, attestations, performance scores, and credentials.

Each user profile contains several interrelated data objects, beginning with the personal account information that includes the persistent identifier, contact data, authentication credentials, and access preferences. Associated with each profile is an interaction log, which contains a series of data entries corresponding to discrete service experiences or transactions. Each entry within the interaction log includes metadata such as a timestamp, rater identity, rating category, rating value, and contextual descriptors that enable meaningful aggregation and analysis. The system is designed to ingest data from multiple verified sources, including employer systems, customer interfaces, and third-party rating applications, using standardized API endpoints. Each interaction entry is validated for authenticity before being accepted into the user's permanent record.

The ratings data are further organized into score windows, which represent time-bounded collections of interactions used for calculating dynamic performance metrics. The use of score windows allows the system to apply recency weighting and statistical smoothing, ensuring that performance evaluations evolve proportionally with recent activity. Each window includes both raw and processed data, enabling recalculation in response to updated interactions or privacy modifications. The scoring process applies normalization algorithms that account for differing rating patterns among raters, ensuring fairness and reducing the impact of outlier behavior. The resulting scores, once verified, are stored within the user's performance profile as both numerical values and summarized metrics.

The credential entity represents the formalized, verifiable output of the system's computation processes. Each credential encapsulates key performance indicators derived from the aggregated and validated data within the user's account. A credential includes a data payload containing the persistent identifier, computed performance scores, rating summaries, employer attestations, issuance timestamp, and expiration metadata. To ensure integrity and authenticity, the credential payload is digitally signed using a cryptographic key maintained within a secure key management subsystem. This signature acts as a tamper-detection mechanism; any unauthorized modification to the credential data would invalidate the digital signature and render the credential unverifiable.

The lifecycle of a credential begins with issuance, which occurs upon request from the user or automatically after the system validates that sufficient verified interactions have been recorded. During issuance, the credential generation service assembles relevant data according to the user's privacy preferences. The digital signature is applied, and the credential is stored in an immutable record store, which may be implemented using a secure, append-only ledger. Once issued, the credential can be accessed by the user for sharing or verification purposes. Each time a credential is shared, the verification service validates the signature and returns an authenticity status along with any user-approved performance data. The system also maintains versioning, ensuring that previous credentials remain archived for auditability even after updated versions are generated.

Credential updates may occur when the user receives new verified interactions or modifies privacy preferences. When new performance data are recorded, the system recalculates the user's score windows and generates an updated credential. Each version of the credential is assigned a distinct issuance timestamp and digital signature, enabling third parties to confirm which version they are reviewing. Privacy modifications trigger regeneration of the credential payload to exclude or include selected data categories according to the user's revised preferences. These updates occur in a controlled manner that preserves the authenticity of previously issued credentials while ensuring that future verifications reflect the user's most current visibility selections.

Revocation is an integral part of the credential lifecycle, designed to address cases of suspected compromise, user-initiated privacy withdrawal, or administrative error. Revocation actions are executed through the credential management service, which invalidates the existing digital signature and updates the verification registry to mark the credential as revoked. Verification attempts made against a revoked credential return a status message indicating that the credential is no longer valid. Revocation logs are permanently stored in an immutable audit record, allowing system administrators or auditors to confirm the legitimacy and timing of any credential withdrawal.

Data persistence within the system relies on a combination of relational and distributed storage mechanisms to balance query efficiency, redundancy, and resilience. The profile database stores core user and credential entities, while the interaction database retains detailed performance and rating data. A separate verification registry maintains credential hashes and signature references for rapid lookup during authenticity checks. To enhance fault tolerance, these databases may be replicated across geographically distributed nodes, ensuring system availability even in the event of localized failures. Encryption at rest and in transit ensures compliance with privacy and data protection regulations, preventing unauthorized access or data leakage.

The data structures supporting this invention are further characterized by interoperability and portability. The credential format conforms to standardized data schemas compatible with digital wallet frameworks, professional networking platforms, and human resource management systems. This allows users to export and embed their verified credentials within external platforms without altering their integrity or validity. The persistent identifier ensures that, regardless of the number of credentials or platforms used, the user's professional record remains unified, traceable, and verifiable across their entire career trajectory.

Through its carefully structured data relationships and lifecycle management processes, the system enables a seamless and secure method of maintaining verifiable performance records. Each element of the data model-from the persistent identifier to the credential entity-contributes to a cohesive mechanism that supports trust, transparency, and long-term portability in the professional ecosystem. The result is a data framework that transforms fragmented performance history into a durable and cryptographically verifiable career credential, preserving authenticity and user control in equal measure.

The rating and scoring framework of the present invention forms the analytical core of the system, enabling the generation of reliable, dynamic, and verifiable indicators of an individual's professional performance. This component of the invention is designed to ensure that the aggregation of ratings from multiple verified sources produces a mathematically balanced and empirically trustworthy outcome. The system's scoring logic is grounded in principles of statistical validity, recency weighting, and anomaly detection, which together ensure that the resulting performance credential accurately reflects both the individual's service history and their ongoing performance consistency.

The rating process begins with the collection of data points representing discrete service interactions. Each rating record corresponds to a specific event in which the individual's professional conduct, customer service quality, or job performance was evaluated by an authorized rater. Raters may include customers, supervisors, peers, or automated systems that measure predefined service metrics. Each rating submission is linked to the individual's persistent identifier, ensuring permanent association between the feedback and the corresponding professional. Ratings are transmitted through secure communication channels and validated for authenticity through digital signatures or authentication tokens before being stored in the system's interaction database.

Once ratings have been recorded, the system applies a multilayered scoring algorithm designed to produce both category-specific and composite performance scores. Each rating record contains one or more categorical elements, such as communication quality, timeliness, accuracy, or professionalism. The scoring engine calculates a weighted average for each category, followed by a global composite score derived from the weighted contribution of all categories. Weighting factors may be adjusted based on the relative importance of different performance dimensions, as defined by the user's occupational field or employer guidelines. The engine incorporates normalization techniques to account for variations in rating patterns across raters, thereby preventing bias or distortion caused by outlier values or inconsistent scoring behaviors.

The scoring process incorporates a recency weighting model that emphasizes more recent interactions without disregarding the long-term historical record. Each rating is assigned a time-dependent weight determined by a decay function. This function gradually reduces the influence of older ratings while preserving sufficient historical continuity to reflect long-term performance trends. The decay rate may be dynamically adjusted based on the volume of recent interactions, the frequency of new ratings, or the stability of performance indicators. This temporal weighting ensures that the credential remains responsive to changes in an individual's performance over time while discouraging manipulation through short-term rating spikes.

Statistical confidence calculations are applied to each score to quantify the reliability of the underlying data set. The confidence metric is derived from variables such as the number of ratings, variance among ratings, and distribution of rating sources. The system computes confidence intervals that indicate the degree of certainty associated with the reported performance score. In cases where the number of verified interactions is below a defined minimum threshold, the system withholds public credential generation until sufficient data have been collected to produce a statistically meaningful result. This mechanism prevents premature publication of unreliable or unrepresentative performance records.

Following score computation, the credential generation subsystem compiles a summary of the verified scores and generates a cryptographically verifiable credential. This process involves the creation of a structured data payload containing the individual's persistent identifier, calculated performance metrics, metadata describing rating sources, and a digital timestamp. A cryptographic signature is then applied using a private key managed by the system's key management infrastructure. The signature ensures that the credential cannot be altered without detection and serves as the primary mechanism for third-party verification. The credential may be represented as a portable digital file, a cryptographic token, or a machine-readable record compatible with digital wallet and professional network standards.

Verification is achieved through a secure validation protocol that allows any authorized party to confirm the authenticity of a credential without accessing underlying private data. When a third party initiates a verification request, the system retrieves the credential's public record and validates the digital signature using a corresponding public key. The verification process confirms that the credential was issued by an authorized system, that it has not been altered, and that it remains in active status. If the credential has been revoked or superseded, the verification response indicates its invalidity along with the reason for revocation, such as privacy updates, user requests, or security incidents. This independent verification model ensures trustworthiness even when verification occurs outside the user's or employer's platform environment.

The system's verification protocol also includes a trust propagation mechanism that maintains a chain of authenticity between the credential issuer and any relying party. This chain relies on a certificate authority structure or a decentralized identity framework that anchors credential signatures within a verifiable trust network. As a result, employers, clients, or other verifiers can authenticate credentials across domains and industries without reliance on proprietary systems or intermediaries. Each verification event is logged in an immutable audit record, allowing for transparency in credential usage and compliance with data governance requirements.

An anomaly detection and fraud prevention layer operates in conjunction with the rating and scoring system to ensure that all ratings are genuine and free from manipulation. This subsystem employs algorithms that detect irregular rating patterns, such as sudden influxes of high or low scores from a single source, duplicated ratings from identical IP addresses, or statistically improbable rating sequences. Detected anomalies trigger automated flags and may initiate manual review processes to validate authenticity. Verified fraudulent entries are quarantined or removed, and affected scores are recalculated to restore accuracy. This multi-tiered integrity check ensures that performance scores reflect genuine and unbiased feedback.

In addition to preventing fraud, the system promotes fairness and comparability by using reference cohorts for benchmarking. Performance scores may be contextualized within statistical distributions of peers who share similar roles, industries, or service categories. The engine computes percentile rankings that indicate how an individual's score compares to a relevant peer group. This comparative measure adds contextual value to the credential, allowing prospective employers or clients to interpret the score relative to industry norms rather than in isolation.

The verification mechanism operates continuously and autonomously, providing real-time confirmation of credential validity. Whenever a verification request occurs, the system performs a live check against the most recent credential status stored within the verification registry. This ensures that even if a credential has been revoked or replaced, verifiers receive accurate, up-to-date information. Verification responses may include additional metadata such as credential issuance date, expiration period, and revocation reason codes, providing a transparent and auditable framework for professional trust.

Through its integrated rating, scoring, and verification mechanisms, the invention establishes a technologically robust and statistically defensible method of professional reputation assessment. The system transforms subjective and fragmented performance feedback into an objective, mathematically grounded credential that is cryptographically verifiable and universally portable. By combining algorithmic rigor with secure verification and trust propagation, the invention provides a comprehensive foundation for career-long reputation validation in digital employment ecosystems.

The present invention integrates comprehensive privacy management and user control mechanisms to ensure that individuals retain full authority over the visibility and dissemination of their professional performance information. The privacy framework of the system is designed not only to comply with prevailing data protection regulations but also to empower users with granular control over how their credentials are displayed, shared, and maintained. This section describes the system's approach to privacy enforcement, user-managed data disclosure, and the process through which employer attestations are securely integrated into the verifiable credential without compromising confidentiality or authenticity.

Privacy within the system operates as a user-centric feature rather than a static administrative function. Each user account includes a privacy profile that defines disclosure preferences for different categories of information, such as ratings, performance scores, attestations, and credential status. These preferences are stored as structured policies within the privacy management subsystem. Users may choose to make certain data public, restrict access to specific employers or verification requests, or conceal categories entirely. For example, a user may allow the disclosure of aggregated performance scores while keeping employer-specific attestations private, or may choose to share only data from defined time ranges. The system enforces these selections at every stage of credential generation and verification, ensuring that credential outputs and verification responses reflect only those elements authorized by the user's privacy configuration.

The user interface provides mechanisms for creating, reviewing, and modifying privacy preferences through an intuitive control panel. Within this interface, users may toggle visibility of particular data classes, define recipient-specific rules, or set expiration conditions for shared credentials. The system automatically updates the privacy profile whenever a change is made, and all subsequent credential generations adhere to the revised policy without the need for manual intervention. When credentials are shared externally, embedded metadata communicates which data types are visible, preventing over-disclosure. This design enables users to safely share professional achievements with prospective employers or clients while preserving sensitive details of their employment history.

The privacy subsystem operates in concert with the credential generation service. When a credential is requested, the generation process consults the user's active privacy policy and constructs a credential payload that includes only authorized data elements. The payload is then digitally signed to prevent tampering or unauthorized augmentation. Because the digital signature covers the entire credential data set, any attempt to alter or append private information after issuance would invalidate the credential upon verification. This ensures that privacy controls are not only policy-based but also technically enforced at the cryptographic level. Even the system administrators cannot override the user's privacy rules once a credential has been signed and issued.

To enhance transparency, users can access an activity log that records every instance of credential generation, modification, or verification. This log serves as both a privacy audit and a data access record, allowing users to track how their credentials have been viewed and by whom. Each entry in the activity log includes a timestamp, verification requester identification (if disclosed), and a record of which data fields were accessed during verification. These immutable records reinforce user trust and demonstrate compliance with privacy and data protection obligations.

Employer attestations represent a distinct but integrated component of the privacy and verification architecture. An employer attestation is a digitally verifiable statement confirming a user's employment period, role, or performance endorsement. Employers interact with the system through a secure attestation portal that verifies their organizational identity before permitting submission of attestations. Authentication methods may include digital certificates, multi-factor verification, or federated identity protocols. Once verified, the employer provides employment details such as start and end dates, job title, and optional comments or endorsements. These attestations are cryptographically signed by the employer's key and stored within the user's attestation registry.

When a user elects to include employer attestations in their credential, the credential generation service retrieves the relevant attestations from the registry, validates the employer signatures, and incorporates the verified attestations into the credential payload. The inclusion process respects the user's privacy preferences: only attestations authorized for disclosure are included, and others remain inaccessible to credential verifiers. Each included attestation is accompanied by metadata that identifies its verification source, issuance date, and validation status. This method ensures that third parties reviewing the credential can trust that any displayed employment record has been verified directly by a legitimate employer and has not been altered or self-generated by the user.

The system allows for dynamic management of attestations. Users may revoke consent to share an attestation at any time, upon which the credential generation process will exclude that attestation from future credential versions. Employers may also withdraw or amend attestations in accordance with policy or upon discovery of inaccuracies. When such modifications occur, the system maintains the historical record for audit purposes while ensuring that any publicly verifiable credentials reflect the current and accurate state of employment confirmation. This dual-level revocation framework maintains both transparency and integrity while giving each party autonomy over their data contributions.

Privacy enforcement extends beyond user settings to encompass system-level data protection measures. All personally identifiable information is encrypted in storage and transmission. The system employs access control lists and role-based authorization to limit administrative access to sensitive data. Furthermore, differential privacy and data minimization techniques are applied to analytics processes to prevent inadvertent exposure of individual-level information. Logs containing verification and access data are anonymized for statistical use, preserving aggregate insights while eliminating personal identifiers.

The employer attestation process contributes significantly to the verifiability and credibility of the overall credential. By incorporating verified employment history and endorsements directly into the credential, the system provides an objective context for the performance data. Prospective employers or clients reviewing a credential can confirm not only that performance ratings are authentic but also that they were accrued during verified periods of employment. This linkage of verified timeframes with performance outcomes distinguishes the system from conventional rating or reference tools, which often lack temporal validation or cryptographic assurance.

To facilitate interoperability and privacy compliance, the invention supports selective disclosure protocols that enable users to share proofs of authenticity without revealing underlying data. Using cryptographic techniques such as zero-knowledge proofs or selective credential disclosure, a user can demonstrate the validity of a credential or attestation to a verifier without disclosing sensitive information, such as specific rating details or employment identifiers. This feature strengthens privacy assurance while maintaining verifiability, allowing users to present credentials in highly privacy-sensitive contexts, including background checks or industry certifications.

The privacy, user control, and employer attestation features of the invention collectively establish a system that is not only technically secure but also ethically and legally aligned with data sovereignty principles. Users maintain perpetual ownership of their career-long data, determining how it is shared, who can see it, and when it may be withdrawn. Employers contribute verified attestations in a controlled and auditable manner, and verifiers receive only as much information as the user consents to disclose. This equilibrium between transparency and privacy is essential to establishing trust in digital credential ecosystems and is a central advantage of the present invention.

The invention incorporates a comprehensive security framework that underpins every functional layer of the verifiable service-performance credential system. Because the invention involves the collection, storage, and dissemination of professional data over extended timeframes, its design emphasizes cryptographic integrity, fraud prevention, and resilient deployment. The security and anti-fraud architecture ensures that every credential issued, verified, or revoked is traceable, tamper-resistant, and compliant with best practices in cybersecurity and data protection. The following section outlines the system's principal security mechanisms, anti-fraud operations, and implementation considerations that enable reliable, large-scale adoption.

The system employs a multilayered security model that begins with strong identity assurance at the point of user registration. Each user undergoes a verification process that may include email confirmation, biometric validation, multifactor authentication, or integration with verified employment databases. Once authenticated, the user receives a persistent identifier, which serves as the immutable anchor of their credential history. The generation of this identifier utilizes cryptographically secure randomization and hashing algorithms to eliminate duplication and mitigate identity spoofing. The identifier is stored separately from personally identifiable information to reduce the risk of correlation or misuse in the event of data exposure.

All communications within the system are encrypted using transport-layer security protocols. Data transmitted between client devices, API gateways, and backend services are protected through asymmetric key exchange and session-based encryption. At rest, sensitive information is encrypted using strong symmetric encryption methods with keys managed by a dedicated key management service. This subsystem enforces regular key rotation, secure key escrow, and restricted key access, ensuring that even privileged administrative users cannot directly access raw credential or rating data. The design anticipates long-term data retention by employing encryption algorithms that can be upgraded or rekeyed without disrupting credential validity, thus supporting the career-long persistence of records.

Anti-fraud protections are integral to maintaining the integrity of performance data. The system continuously monitors rating activity using anomaly detection models trained to identify irregular or manipulative behaviors. These models evaluate patterns such as abrupt surges in identical ratings, duplicate entries from single sources, or statistically improbable rating distributions. Upon detecting anomalies, the system automatically isolates questionable data for further review, recalculates affected scores without the suspect entries, and generates audit flags for administrative evaluation. Fraudulent ratings are permanently excluded from the credential computation pipeline, preserving the authenticity of all published credentials.

An abuse detection module operates in tandem with the anomaly system to enforce integrity at the interaction level. This module establishes thresholds for unique raters, minimum verified interactions, and maximum rating frequency within a defined period. Users or raters exceeding normal behavioral limits trigger rate limiting or temporary suspension, preventing manipulation of the scoring system through automated or coordinated attacks. Additionally, the system maintains a provenance ledger of all interactions, which provides immutable historical documentation of each event, including submission time, rater identity verification, and signature validation. This ledger enables retrospective forensic analysis, ensuring accountability across all parties.

The security framework extends to the verification process, which must operate securely even in external environments. Each credential includes a digital signature generated through public-key cryptography. Verifiers access only the credential's public data and signature, allowing them to validate authenticity without direct access to private system databases. Verification endpoints operate through read-only interfaces that provide cryptographic validation of credential integrity and return verification results in standardized, privacy-compliant formats. In cases where a credential is revoked, expired, or compromised, verification attempts return a revocation notice referencing the reason for invalidation. This guarantees transparency and maintains verifier confidence in the credentialing network.

Revocation is handled through an automated protocol that ensures immediate invalidation of compromised or outdated credentials. When revocation occurs, the corresponding digital signature is marked inactive, and the credential record is moved to a secure revocation registry. The registry is maintained as an immutable, timestamped ledger accessible to verifiers and auditors. This mechanism ensures that once a credential is revoked, it cannot be reused or misrepresented. The system supports both user-initiated and system-initiated revocations, the latter triggered automatically in response to detected anomalies, fraudulent ratings, or privacy updates.

To ensure continued trustworthiness, the invention implements a key rotation and renewal policy that regularly regenerates cryptographic keys used in credential signing. This prevents the long-term exploitation of compromised keys and aligns with established cryptographic lifecycle standards. Key rotations are executed in a manner that preserves backward compatibility with previously issued credentials. Historical credentials remain verifiable through archived key references stored in the credential validation registry, allowing verification of credentials issued years or decades prior. This design consideration supports the system's purpose as a career-long credential repository.

System-wide security is reinforced through continuous auditing and compliance monitoring. The invention maintains a comprehensive audit log that captures every material action within the system, including rating submissions, credential issuances, verifications, and privacy modifications. These logs are immutable and cryptographically hashed to prevent tampering. Audit records serve as evidence for dispute resolution, internal review, and compliance verification. The system may further implement intrusion detection and behavior-based access monitoring, identifying unauthorized access attempts and alerting administrators to potential security incidents in real time.

Implementation of the system can occur in cloud-based, hybrid, or on-premises environments, depending on deployment requirements. In large-scale implementations, cloud infrastructure offers scalability, redundancy, and fault tolerance, allowing for continuous operation even under high verification demand. Containerized microservices architecture allows each subsystem-identity management, rating processing, credential signing, privacy enforcement, and verification-to scale independently. Load balancing, horizontal scaling, and content distribution networks ensure high availability and low-latency performance for global verification operations.

Data residency and jurisdictional compliance are addressed through regionalized data storage, allowing organizations to maintain conformity with local privacy regulations such as the General Data Protection Regulation (GDPR) or the California Consumer Privacy Act (CCPA). Data partitions ensure that information from different regions remains isolated, and cross-border data transfers occur only under cryptographically protected and policy-compliant conditions. The design provides flexibility for enterprises and governments to adopt the system while maintaining their regulatory obligations.

The anti-fraud and verification subsystems are complemented by human review mechanisms to handle exceptional cases. When anomalies cannot be conclusively resolved by automated means, flagged interactions are routed to an adjudication queue for manual verification. Authorized reviewers assess evidence of authenticity, including rater identity and corroborating documentation. Once the review is complete, the findings are recorded in the audit ledger, and appropriate corrective actions are applied. The combination of automated detection and human oversight ensures that the credentialing system maintains fairness, transparency, and integrity without relying solely on algorithmic decision-making.

From an operational perspective, the system's architecture supports interoperability with external systems through standardized communication protocols and data schemas. Credential data can be transmitted or validated through application programming interfaces that conform to open standards, allowing integration with résumé databases, professional networking platforms, human resources systems, and digital identity frameworks. These integrations expand the reach and utility of the credential while preserving the security guarantees of the core system. All external connections are authenticated through tokenized access control to prevent unauthorized data exchange.

The invention's implementation strategy emphasizes durability and trust across decades of use. Redundant storage systems, periodic integrity checks, and migration capabilities ensure that data remains accessible and verifiable even as technologies evolve. Backward-compatible credential verification guarantees that earlier credentials remain functional despite software upgrades or cryptographic key changes. The modular design allows future incorporation of emerging technologies, such as decentralized identity systems, blockchain anchoring, or advanced zero-knowledge verification methods, without requiring fundamental alterations to the core credentialing model.

In operation, the combined security and anti-fraud mechanisms create a closed-loop assurance system that prevents falsification, ensures authenticity, and maintains user confidence. By embedding encryption, verification, and integrity validation at every operational layer, the invention provides a self-sustaining ecosystem of trust.

Users benefit from a lifelong professional credential immune to manipulation; employers and verifiers gain access to transparent, trustworthy performance records; and administrators maintain a secure, compliant infrastructure capable of evolving with industry standards.

The invention delivers a verifiable credentialing system that upholds authenticity, privacy, and continuity for the duration of an individual's career. It establishes a technological foundation for transparent professional reputation management, bridging the gap between individual achievement and institutional trust in the modern digital economy.

### Detailed Description of Figures

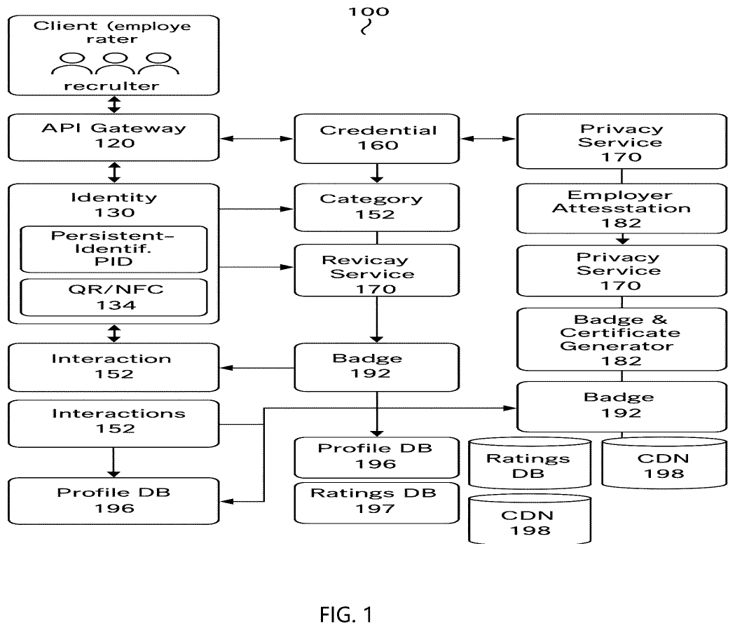

As illustrated in FIG. 1, a system 100 comprises one or more client devices 110 executing an application 112 through which employees, raters, and verifiers interact with the platform. The client devices 110 may include smartphones, tablets, or computers that access the application 112 via a network connection. An API gateway 120 mediates communication between the client devices 110 and various back-end services, providing authentication, encryption, and data routing. An identity service 130 is configured to issue a persistent identifier (PID 132) for each employee, enabling continuous association of the employee's performance data throughout their career. The identity service 130 also generates a scannable code, such as a QR or NFC tag 134, which resolves to the employee's profile when scanned by a verifier.

An interaction service 140 records service interactions 142 initiated by customers, employers, or other raters. A rating engine 150 computes category scores 152 and an overall score 154 based on the recorded interactions 142. The rating engine 150 applies weighting factors that account for recency, consistency, and statistical confidence. A credential service 160 generates a verifiable credential 162 that encapsulates the computed scores and identification data. The credential 162 is digitally signed using cryptographic keys maintained by a key manager 166, producing a verification link 164 that enables third parties to confirm authenticity.

A privacy and policy service 170 enforces employee-defined disclosure settings that determine which elements of the credential are visible during verification. An employer attestation service 180 collects verified employment data and generates a corresponding employment timeline 182. A badge and certificate generator 190 produces graphical badges 192 and certificate documents 194 that embed the verification link 164 and a cryptographic signature fingerprint. Data are maintained in a storage subsystem 195 that includes a profile database 196, a ratings database 197, a content distribution network storage 198 for distributing graphical assets, and an immutable audit log 199 that records all credential-related events for traceability.

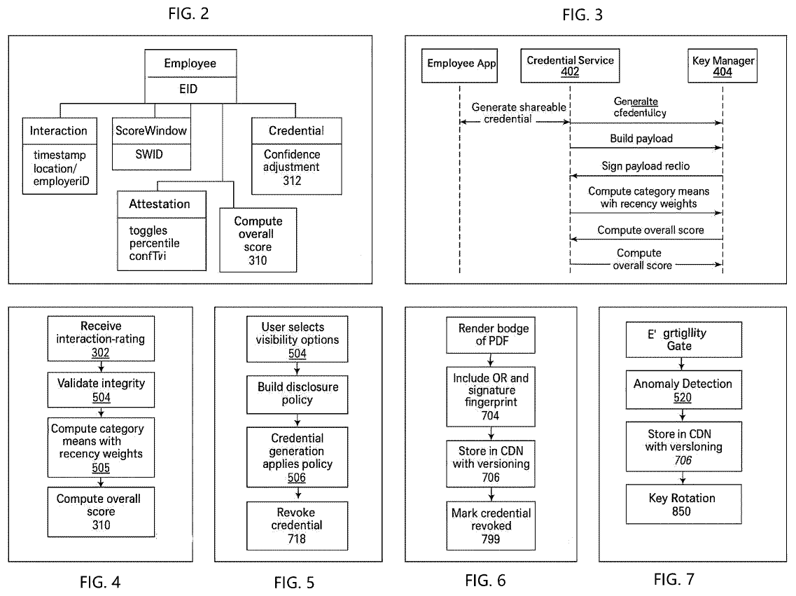

FIG. 2 depicts the core data model implemented by the system 100. An Employee entity is associated with multiple Interactions, each interaction representing a verified service engagement linked to one or more raters or employers. Each employee maintains a rolling ScoreWindow, which aggregates recent interactions within a defined timeframe to calculate updated performance metrics. The data model further includes one or more Credential entities that store verifiable credential records corresponding to each issuance event. Optional Attestations from employers or supervisors may also be associated with the Employee entity, providing verified employment details such as positions held and timeframes. Each Employee entity maintains a PrivacyProfile object that governs the selective disclosure of performance and attestation data according to user preferences. Badge and certificate assets generated by the badge and certificate generator 190 are versioned and linked to corresponding Credentials to ensure consistency between visual and data representations of the employee's record.

FIG. 3 illustrates a flow 300 depicting the rating ingestion and score computation process. At step 302, the system 100 receives a rating submission from a verified rater. The submission is validated at step 304 for integrity, authenticity, and uniqueness, confirming that it originates from a legitimate rater and that no duplicate rating exists for the same interaction. At step 306, the validated interaction is stored as service interaction data 142 in the ratings database 197, and the employee's score window is updated accordingly. At step 308, category scores 152 are recalculated based on the new data, with recency weighting applied to emphasize recent performance trends. At step 310, the overall score 154 is computed using statistical confidence adjustments 312 that account for data variance and rating sample size. At step 314, a percentile value is generated, situating the employee's performance relative to a peer cohort. At step 316, an updated score event is emitted, triggering downstream processes such as credential regeneration or user notification.

FIG. 4 illustrates a credential issuance and verification sequence 400. The sequence begins when an employee application 112 initiates a credential generation request. At block 402, the credential service 160 constructs a credential payload that includes the employee's persistent identifier PID 132, computed performance scores 152 and 154, and any authorized attestations or metadata according to the active privacy policy. At block 404, the key manager 166 applies a digital signature to the payload, producing a verifiable credential 162. At block 406, the badge and certificate generator 190 renders a graphical badge 192 containing a QR code that encodes the verification link 164. When a recruiter or verifier scans the QR code at block 408, the verification endpoint 410 validates the digital signature using public cryptographic keys and returns a read-only view of the credential. The rendered view includes credential status, issuance timestamp, and a summary of performance metrics, ensuring transparent and tamper-evident verification.

FIG. 5 illustrates a privacy control flow 500 that governs how employees manage the visibility of credential data. At step 502, the employee accesses a sharing interface provided through the application 112. At step 504, the employee selects visibility options defining whether to include specific data types such as employer attestations, category scores 152, overall scores 154, or interaction counts. At step 506, the system 100 generates and stores a disclosure policy in the privacy and policy service 170, associating it with the employee's PrivacyProfile. During credential creation at step 508, the credential service 160 retrieves and applies this disclosure policy to construct a credential 162 that includes only the authorized data fields. At step 510, if the employee revokes permission or disables sharing, the credential 162 is marked inactive, and verification attempts against the verification link 164 return a hidden or revoked status. This process ensures that privacy preferences are enforced consistently across all system operations.

FIG. 6 illustrates a badge and certificate generation process 700 conducted by the badge and certificate generator 190. At step 702, visual assets such as badges 192 and certificate documents 194 are rendered using data from the corresponding credential 162. At step 704, the rendered assets include QR codes that encode the verification link 164 and a signature fingerprint corresponding to the credential's cryptographic signature. At step 706, the generated assets are stored in the content distribution storage 198 with full version control and access permissions. At step 708, when a credential 162 is revoked or superseded, the related assets are marked as revoked, and verification endpoints display a revocation notice to prevent misuse. This process ensures that visual and digital representations of credentials remain synchronized, authenticated, and tamper-evident.

FIG. 7 illustrates a security and anti-fraud pipeline 800 designed to maintain the integrity of all rating and credentialing activities. Eligibility gates 810 enforce minimum thresholds for unique raters or verified interactions before credential issuance. Anomaly detection modules 820 analyze rating data to identify irregular or potentially manipulative patterns. Abuse rules 830 are applied to detect and block rating behaviors inconsistent with legitimate service activity. Cases requiring further analysis are escalated to a manual review queue 840, where system administrators assess evidence of authenticity. Key rotation procedures 850 ensure continued cryptographic robustness by periodically replacing signing keys managed by the key manager 166. All credential issuance, revocation, and verification events are recorded within the immutable audit log 199, which serves as a permanent compliance and forensic record. This multilayered pipeline ensures that the credentialing system resists tampering, maintains trustworthiness, and provides verifiable transparency across its entire operational lifecycle.

What is claimed is:

1. A system for generating and maintaining a verifiable service-performance credential for an individual, comprising:
a. a user account associated with a persistent identifier uniquely assigned to the individual;
b. a rating engine configured to receive and aggregate service interaction data associated with the user account;
c. a scoring module configured to compute at least one performance score based on the aggregated service interaction data, wherein the performance score is calculated as a weighted function of recency, statistical confidence, and interaction frequency;
d. a credential generator configured to create a cryptographically verifiable credential comprising the performance score and a digital signature authenticating the credential; and
e. a verification interface configured to enable third parties to validate the authenticity of the credential without accessing underlying rating data.

2. The system of claim 1, wherein the persistent identifier is encoded in a scannable medium comprising a quick response (QR) code or near-field communication (NFC) tag that resolves to the user account through a secure digital link.

3. The system of claim 1, wherein the performance score is recalculated dynamically upon receipt of additional verified interactions or updates to the rating data.

4. The system of claim 1, wherein the credential generator applies a rotating key digital signature to each credential to prevent falsification or reuse of outdated credentials.

5. The system of claim 1, further comprising a credential registry configured to maintain versioned records of all issued credentials, including issuance timestamps, signature identifiers, and revocation statuses.

6. The system of claim 1, wherein the verification interface provides a real-time validation response indicating whether the credential is active, revoked, or expired.

7. The system of claim 1, further comprising a privacy management subsystem configured to enforce user-defined visibility preferences for specific credential elements, including performance categories, employer attestations, and time ranges.

8. The system of claim 1, wherein the user account must accumulate a minimum threshold of verified service interactions before a credential becomes publicly verifiable.

9. The system of claim 1, further comprising an employer attestation module configured to receive digitally signed attestations from verified employers, wherein the attestations confirm employment periods and roles for incorporation into the credential.

10. The system of claim 1, wherein all data transactions between the user account, rating engine, and credential generator are encrypted using asymmetric cryptographic protocols.

11. The system of claim 1, further comprising a fraud detection module configured to identify irregular rating patterns by applying statistical anomaly detection algorithms to interaction data prior to score computation.

12. The system of claim 1, wherein the credential generator exports the verifiable credential as a digital badge or certificate compatible with external platforms including résumé databases, professional networking systems, and digital identity wallets.

13. The system of claim 1, wherein the credential registry is implemented using an immutable, append-only data structure that records credential issuance, revocation, and verification events.

14. The system of claim 1, further comprising an audit log configured to record each verification attempt with corresponding timestamps and verification results to support compliance and transparency.

15. The system of claim 1, wherein the scoring module normalizes performance data across multiple rating sources to reduce bias and enhance statistical consistency in the computed performance score.

16. A computer-implemented method for generating and maintaining a transferable service-performance credential for an individual, the method comprising:
a. establishing a user account associated with a persistent identifier unique to the individual;
b. receiving verified rating data corresponding to service interactions linked to the user account;
c. computing at least one performance score based on the received rating data, wherein the computation includes applying recency weighting and statistical normalization;
d. generating a cryptographically verifiable credential that includes the performance score and a digital signature authenticating the credential;
e. storing the credential in a credential registry; and
f. enabling the individual to share the credential with third parties for verification through a secure digital interface.

17. The method of claim 16, further comprising receiving one or more employer attestations of employment history, digitally signing the attestations, and integrating them into the credential in accordance with user privacy preferences.

18. The method of claim 16, further comprising dynamically recalculating the performance score as new verified interactions are received or as the user modifies disclosure preferences.

19. The method of claim 16, further comprising detecting anomalous or fraudulent rating submissions using statistical pattern analysis and excluding such data from the computation of the performance score.

20. The method of claim 16, further comprising revoking or reissuing the credential in response to detected anomalies, privacy updates, or credential expiration, wherein any revoked credential is marked inactive within the credential registry and returns a revocation status upon verification.
